(19) United States
(12) Patent Application Publication
(10) Pub. No.: US 2023/0292227 A1
(43) Pub. Date: Sep. 14, 2023

(54) METHOD FOR DELIVERY METHOD SWITCH FROM UNICAST TO MULTICAST

(71) Applicant: ZTE CORPORATION, Shenzhen (CN)

(72) Inventors: Menghan WANG, Shenzhen (CN); Zhendong LI, Shenzhen (CN); Shuang LIANG, Shenzhen (CN)

(73) Assignee: ZTE CORPORATION, Shenzhen (CN)

(21) Appl. No.: 18/112,542

(22) Filed: Feb. 22, 2023

Related U.S. Application Data
(63) Continuation of application No. PCT/CN2020/120458, filed on Oct. 12, 2020.

(51) Int. Cl. H04W 48/16; H04W 48/20; H04W 72/30

(52) U.S. Cl. CPC H04W 48/16; H04W 48/20; H04W 72/30

(57) ABSTRACT

A wireless communication method for use in an access and mobility management function is disclosed. The method comprises transmitting, to a network function, information related to a multicast broadcast service of a radio access network node.

This application is a continuation of PCT/CN2020/120458, filed Oct. 12, 2020, the content of which is incorporated herein by reference in its entirety.

### TECHNICAL FIELD

This document is directed generally to wireless communications.

### BACKGROUND

The 3rd generation partner project (3GPP) originally developed Multimedia Broadcast Multicast Service (MBMS) for 3G/4G networks for video broadcasting and streaming services. The MBMS system has been updated to support new services such as those of public safety, cellular internet-of-things (CIoT) and vehicle-to-everything (V2X). With the development and maturity of the 5G system (5GS), the 5GS is expected to provide multicast broadcast services (MBSs) which might be used for different vertical businesses.

### SUMMARY

In the following, terminologies related to the MBS are illustrated. However, it is understood by the skilled person that the below disclosure is not limited to 5G but may also be used in other communication systems.

Multicast communication service: A communication service providing the same service and the same specific content data simultaneously to a dedicated set of user equipments (UEs) (i.e., not all UEs in a multicast coverage are authorized to receive the data).

Multicast session: A session used to deliver the multicast communication service. The multicast session is characterized by the content to send, by the list of UEs that may receive the service and optionally by a multicast area where to distribute it.

Unicast session: A session used to deliver the communication service between single UE and Data Network.

Unicast delivery method: The unicast delivery method means that data is transmitted to single UE by using a packet data unit (PDU) session.

Multicast delivery method: The multicast delivery method means that data is transmitted to a dedicated set of UEs by using a multicast session.

PTP (Point to Point) delivery method: a radio access network (RAN) node delivers separate copies of MBS data packet over radio resources to individual UE.

PTM (Point to Multipoint) delivery method: a RAN node delivers a single copy of MBS data packet over radio resource to a set of UEs.

It should be noted that it might be unclear under certain circumstances how to support a delivery method switch from the unicast delivery method to the multicast delivery method caused by an inter-RAN handover procedure.

This document relates to methods, systems, and devices for a delivery method switch from unicast (delivery method) to multicast (delivery method), and more particularly to a methods, systems, and devices for a delivery method switch from unicast to multicast in response to an inter-radio-access-network-node handover procedure.

The present disclosure relates to a wireless communication method for use in an access and mobility management function. The wireless communication method comprises transmitting, to a network function, information related to a multicast broadcast service of a radio access network node.

Various embodiments may preferably implement the following features:

Preferably, or in some implementations, the wireless communication method further comprises receiving, from the network function, a subscription of the information related to the multicast broadcast service of the radio access network node.

Preferably, or in some implementations, the information related to the multicast broadcast service of the radio access network node is transmitted during or after at least one of a packet data unit, PDU, session establishment procedure, a multicast join procedure or a handover procedure.

Preferably, or in some implementations, the information related to the multicast broadcast service of the radio access network node indicates a capability of the radio access network node supporting the multicast broadcast service.

Preferably, or in some implementations, the information comprises an identifier of the radio access network node.

Preferably, or in some implementations the network function is a session management function.

The present disclosure relates to a wireless communication method for a session management function. The wireless communication method comprises receiving, from an access and mobility management function, information related to a multicast broadcast service of a radio access network node.

Various embodiments may preferably implement the following features:

Preferably, or in some implementations, the wireless communication method further comprises subscribing, to the access and mobility management function, the information related to the multicast broadcast service of the radio access network node.

Preferably, or in some implementations, the information is subscribed during or after at least one of a packet data unit, PDU, session establishment procedure or a multicast join procedure.

Preferably, or in some implementations, the information related to the multicast broadcast service of the radio access network node is received during or after at least one of a packet data unit, PDU, session establishment procedure, a multicast join procedure or a handover procedure.

Preferably, or in some implementations, the information related to the multicast broadcast service of the radio access network node indicates a capability of the radio access network node supporting the multicast broadcast service.

Preferably, or in some implementations, the information related to the multicast broadcast service of the radio access network node comprises an identifier of the radio access network node.

Preferably, or in some implementations, the session management function triggers a delivery method switch between unicast and multicast when the session management function receives the information indicating the capability of the radio access network node supporting the multicast broadcast service (e.g. the radio access network node supports or does not support the multicast broadcast service) or the identifier of the radio access network node.

Preferably, or in some implementations, the information related to the multicast broadcast service of a radio access network node indicates the radio access network node supports the multicast broadcast service.

Preferably, or in some implementations, the session management function triggers a delivery method switch from unicast to multicast when the information indicating that the radio access network node supports the multicast broadcast service or the identifier of the radio access network node.

Preferably, or in some implementations, the wireless communication method further comprises triggering a delivery method switch from a unicast method to a multicast method for at least one multicast service of a wireless terminal and a multicast session joining procedure of the at least one multicast service for the wireless terminal.

Preferably, or in some implementations, the wireless communication method further comprises stopping a user plane function from transmitting data of a multicast service to a wireless terminal via a unicast session.

Preferably, or in some implementations, the stopping the user plane function from transmitting data of the multicast service to the wireless terminal via the unicast session comprises:

transmitting, to a multicast broadcast session management function or the user plane function, a notification of stopping transmitting data of the multicast service to the wireless terminal via the unicast session.

Preferably, or in some implementations, the user plane function comprises a multicast broadcast user plane function.

Preferably, or in some implementations, the method further comprises transmitting, to a network exposure function or a multicast broadcast service function, a notification indicating a delivery method switch from a unicast method to a multicast method for a multicast service of a wireless terminal.

Preferably, or in some implementations, the method further comprises triggering a deactivation procedure of a unicast session.

The present disclosure relates to a wireless communication method for use in a multicast broadcast session management function. The wireless communication method comprises receiving, from a session management function, a notification of stopping transmitting data of a multicast service to a wireless terminal via a unicast session, and configuring a multicast broadcast user plane function to stop transmitting the data of the multicast service to the wireless terminal via the unicast session.

Various embodiments may preferably implement the following feature:

Preferably, or in some implementations, the wireless communication method further comprises transmitting, to a network exposure function or a multicast broadcast service function, a notification indicating a delivery method switch from a unicast method to a multicast method for the multicast service of the wireless terminal.

The present disclosure relates to a wireless communication method for a network function. The wireless communication method comprises receiving, from a session management function, a notification indicating a delivery method switch from a unicast method to a multicast method for a multicast service of a wireless terminal.

Various embodiments may preferably implement the following features:

Preferably, the wireless communication method further comprises transmitting the notification to an application function.

Preferably, the network function is a network exposure function or a multicast broadcast service function.

Preferably, the session management function comprises a multicast broadcast session management function.

The present disclosure relates to a communication node comprising an access and mobility management function. The communication node comprises a communication unit, configured to transmit, to a network function, information related to a multicast broadcast service of a radio access network node.

Various embodiments may preferably implement the following feature:

Preferably, the communication node further comprises a processor configured to perform a wireless communication method of any one of the foregoing described methods.

The present disclosure relates to a communication node comprising a session management function. The communication node comprises a communication unit, configured to receive, from an access and mobility management function, information related to a multicast broadcast service of a radio access network node.

Various embodiments may preferably implement the following feature:

Preferably, the communication node further comprises a processor configured to perform a wireless communication method of any one of the foregoing described methods.

The present disclosure relates to a communication node comprising a multicast broadcast session management function. The communication node comprises:
a communication unit, configured to receive, from a session management function, a notification of stopping transmitting data of a multicast service to a wireless terminal via a unicast session, and
a processor, configured to configure a multicast broadcast user plane function to stop transmitting the data of the multicast service to the wireless terminal via the unicast session.

Various embodiments may preferably implement the following feature:

Preferably, the processor is further configured to perform a wireless communication method of any one of foregoing described methods.

The present disclosure relates to a communication node comprising a network function. The communication node comprises a communication unit, configured to receive, from a session management function, a notification indicating a delivery method switch from a unicast method to a multicast method for a multicast service of a wireless terminal.

Various embodiments may preferably implement the following feature:

Preferably, the communication node further comprises a processor configured to perform a wireless communication method of any one of the foregoing described methods.

The present disclosure relates to a computer program product comprising a computer-readable program medium code stored thereupon, the code, when executed by a processor, causing the processor to implement a wireless communication method recited in any of foregoing methods.

The example embodiments disclosed herein are directed to providing features that will become readily apparent by reference to the following description when taken in conjunction with the accompany drawings. In accordance with various embodiments, example systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the example embodiments and applications described and illustrated herein. Additionally, the specific order and/or hierarchy of steps in the methods disclosed herein are merely example approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

### BRIEF DESCRIPTION OF THE DRAWINGS

FIG. 1 shows a schematic diagram of a 5G system architecture according to an embodiment of the present disclosure.

FIG. 2 shows a schematic diagram of an enhanced architecture providing multicast broadcast service according to an embodiment of the present disclosure.

FIG. 3 shows an example of a schematic diagram of a wireless terminal according to an embodiment of the present disclosure.

FIG. 4 shows an example of a schematic diagram of a wireless network node according to an embodiment of the present disclosure.

FIGS. 5A to 5D shows flowcharts of a procedure of multicast service provision according to an embodiment of the present disclosure.

FIG. 6 shows a multicast service join procedure according to an embodiment of the present disclosure.

FIG. 7 shows a procedure for delivery method switch from unicast to multicast according to an embodiment of the present disclosure.

FIGS. 8A and 8B show the procedure for delivery method switch from unicast to multicast according to an embodiment of the present disclosure.

FIG. 9 shows a flowchart of a process according to an embodiment of the present disclosure.

FIG. 10 shows a flowchart of a process according to an embodiment of the present disclosure.

FIG. 11 shows a flowchart of a process according to an embodiment of the present disclosure.

FIG. 12 shows a flowchart of a process according to an embodiment of the present disclosure.

### DETAILED DESCRIPTION

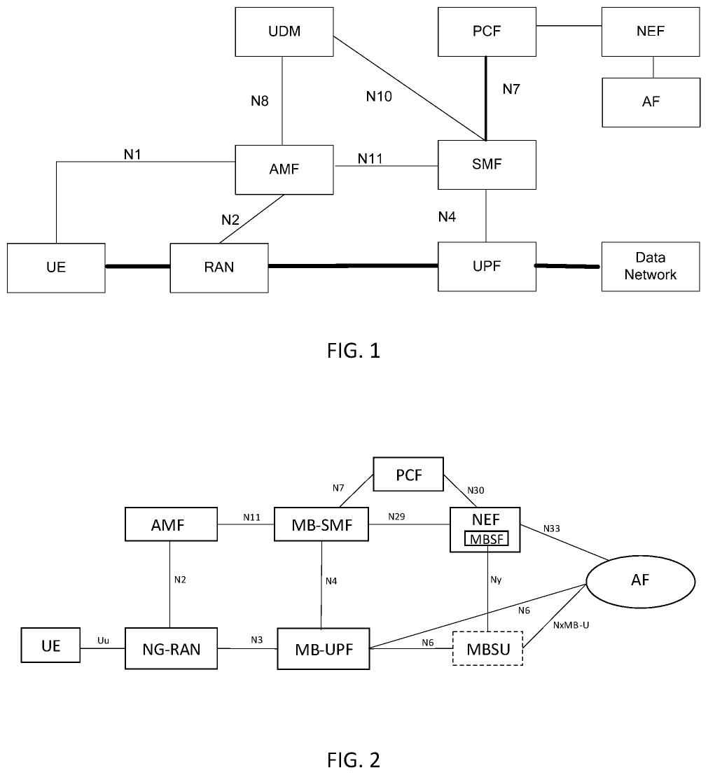

FIG. 1 shows a schematic diagram of a 5G system (5GS) architecture according to an embodiment of the present disclosure. In FIG. 1, the 5GS architecture comprises the following functions (e.g. network functions (NFs)):
UE: User Equipment.
RAN: Radio Access Network. In the present disclosure, the RAN may be equal to RAN node or next-generation RAN (NG-RAN).
AMF: Access and Mobility Management Function

The AMF includes the following functionalities: Registration management, connection management, reachability management and mobility management. The AMF terminates the RAN control plane (CP) interface N2 and NAS (non-access stratum) interface N1, NAS ciphering and integrity protection. The AMF also distributes the SM NAS to the proper SMFs via N11 interface. The AMF provides services for other consumer NFs to subscribe or get notifications of the mobility related events and information.

SMF: Session Management Function

The SMF includes the following functionalities: session establishment, modification and release, UE IP address allocation & management (including optional authorization functions), selection and control of user plane (UP) function, downlink data notification. The SMF may subscribe to AMF for the mobility related events and information.

UPF: User Plane Function

The UPF includes the following functionalities: serving as an anchor point for intra-/inter-radio access technology (RAT) mobility and the external session point of interconnect to data network, packet routing & forwarding as indicated by SMF, traffic usage reporting, QoS (quality-of-service) handling for the UP, downlink packet buffering and downlink data notification triggering, etc.

UDM: Unified Data Management

The UDM manages the subscription profile for the UEs. The subscription includes the data used for mobility management (e.g. restricted area) and/or session management (e.g. QoS profile per slice per DNN (data network name)). The subscription data also includes the slice selection parameters which are used by the AMF for selecting a proper SMF. The AMF and SMF get the subscription from the UDM. The subscription data is stored in the Unified Data Repository (UDR). The UDM uses such data upon receiving the request from the AMF or SMF.

PCF: Policy Control Function

The PCF supports unified policy framework to govern network behavior. The PCF provides access management policy to the AMF and/or session management policy to the SMF and/or UE policy to the UE. The PCF may access the UDR to obtain the subscription information relevant for policy decisions. The PCF also generates the policy to govern network behaviors based on the subscription and indication from the AF. Then, the PCF provides policy rules to CP functions (e.g. AMF and SMF) to enforce the policy rules.

NEF: Network Exposure Function

The NEF supports exposure of capability and events of the network towards the AF. The third-party AF may invoke the service provided by the network via the NEF and the NEF performs authentication and authorization of third-party applications. The NEF also provides translation of the information exchange with the AF and information exchange with the internal NF.

AF: Application Function

The AF interacts with the 3GPP core network for providing services, e.g., to support: application influence on traffic routing, accessing NEF, interacting with the Policy framework for policy control, etc. The AF may be trusted by the operator and may be allowed to interact directly with relevant NFs. The AF which is not allowed by the operator to directly access the NFs may use the external exposure framework via the NEF to interact with relevant NFs. The AF may store the application information in the UDR via the NEF.

FIG. 2 shows a schematic diagram of an architecture enhanced to provide MBS with dedicated NFs according to an embodiment of the present disclosure. In the present disclosure, the multicast broadcast service (MBS) may be equal to multicast service. Enhancement to existing entities and new functional components are illustrated as follows:

1) UE, NG-RAN, AMF, SMF, UPF, NEF and PCF are enhanced to support the MBS.

2) MBSF: Multicast Broadcast Service Function

The MBSF is a new NF used to handle the signaling part to carter for the service layer capability and management. The MBSF may be a part of NEF or be deployed independently. The MBSF provides an interface to the AF or content provider and has an interface connecting to the MBSU.

3) MBSU: Multicast Broadcast Service User plane

The MBSU is a new NF used to handle the payload part to cater for the service layer capability and management. The MBSU may be a standalone entity or collocated with MBSF or MB-UPF (Multicast Broadcast UPF).

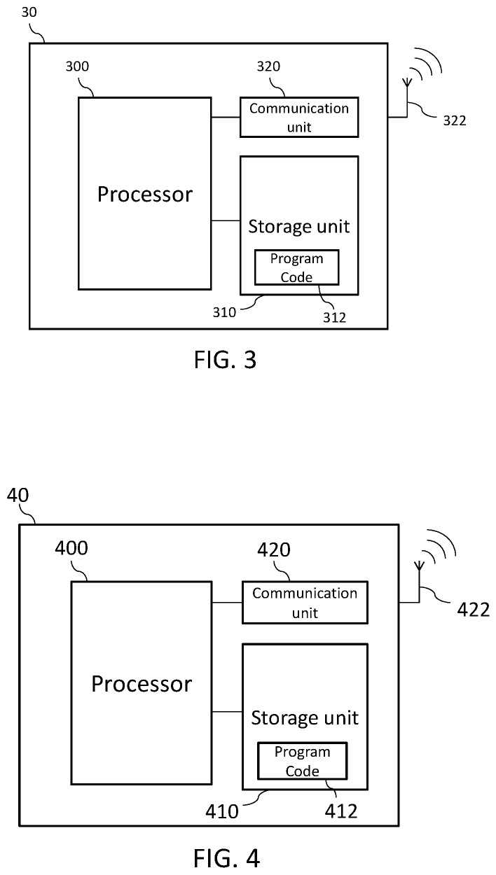

FIG. 3 relates to a schematic diagram of a wireless terminal 30 according to an embodiment of the present disclosure. The wireless terminal 30 may be a UE, a mobile phone, a laptop, a tablet computer, an electronic book or a portable computer system and is not limited herein. The wireless terminal 30 may include a processor 300 such as a microprocessor or Application Specific Integrated Circuit (ASIC), a storage unit 310 and a communication unit 320. The storage unit 310 may be any data storage device that stores a program code 312, which is accessed and executed by the processor 300. Embodiments of the storage unit 312 include but are not limited to a subscriber identity module (SIM), read-only memory (ROM), flash memory, random-access memory (RAM), hard-disk, and optical data storage device. The communication unit 320 may a transceiver and is used to transmit and receive signals (e.g. messages or packets) according to processing results of the processor 300. In an embodiment, the communication unit 320 transmits and receives the signals via at least one antenna 322 shown in FIG. 3.

In an embodiment, the storage unit 310 and the program code 312 may be omitted and the processor 300 may include a storage unit with stored program code.

The processor 300 may implement any one of the steps in exemplified embodiments on the wireless terminal 30, e.g., by executing the program code 312.

The communication unit 320 may be a transceiver. The communication unit 320 may as an alternative or in addition be combining a transmitting unit and a receiving unit configured to transmit and to receive, respectively, signals to and from a wireless network node (e.g. a base station).

FIG. 4 relates to a schematic diagram of a wireless network node 40 according to an embodiment of the present disclosure. The wireless network node 40 may be a satellite, a base station (BS), a network entity, a Mobility Management Entity (MME), Serving Gateway (S-GW), Packet Data Network (PDN) Gateway (P-GW), a radio access network (RAN), a next generation RAN (NG-RAN), a data network, a core network or a Radio Network Controller (RNC), and is not limited herein. In addition, the wireless network node 40 may comprise (perform) at least one network function such as AMF, SMF, UPF, PCF, AF, MB-SMF, MBSU, MBSF, MBSU, NEF, MBUPF, etc. The wireless network node 40 may include a processor 400 such as a microprocessor or ASIC, a storage unit 410 and a communication unit 420. The storage unit 410 may be any data storage device that stores a program code 412, which is accessed and executed by the processor 400. Examples of the storage unit 412 include but are not limited to a SIM, ROM, flash memory, RAM, hard-disk, and optical data storage device. The communication unit 420 may be a transceiver and is used to transmit and receive signals (e.g. messages or packets) according to processing results of the processor 400. In an example, the communication unit 420 transmits and receives the signals via at least one antenna 422 shown in FIG. 4.

In an embodiment, the storage unit 410 and the program code 412 may be omitted. The processor 400 may include a storage unit with stored program code.

The processor 400 may implement any steps described in exemplified embodiments on the wireless network node 40, e.g., via executing the program code 412.

The communication unit 420 may be a transceiver. The communication unit 420 may as an alternative or in addition be combining a transmitting unit and a receiving unit configured to transmit and to receive, respectively, signals to and from a wireless terminal (e.g. a user equipment).

In the present disclosure, ID may an abbreviation of identifier or identification.

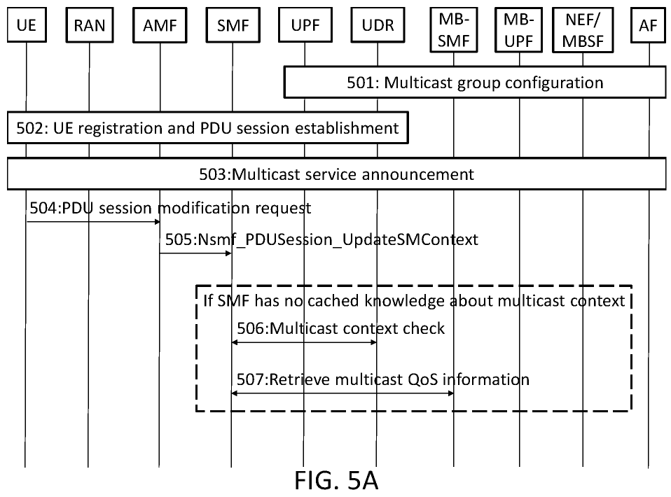

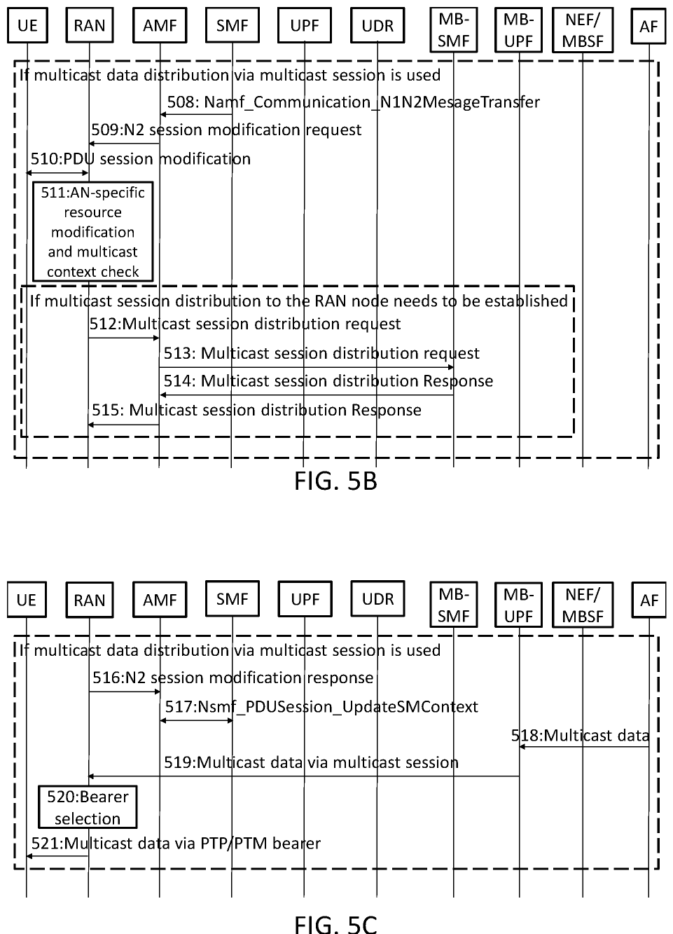

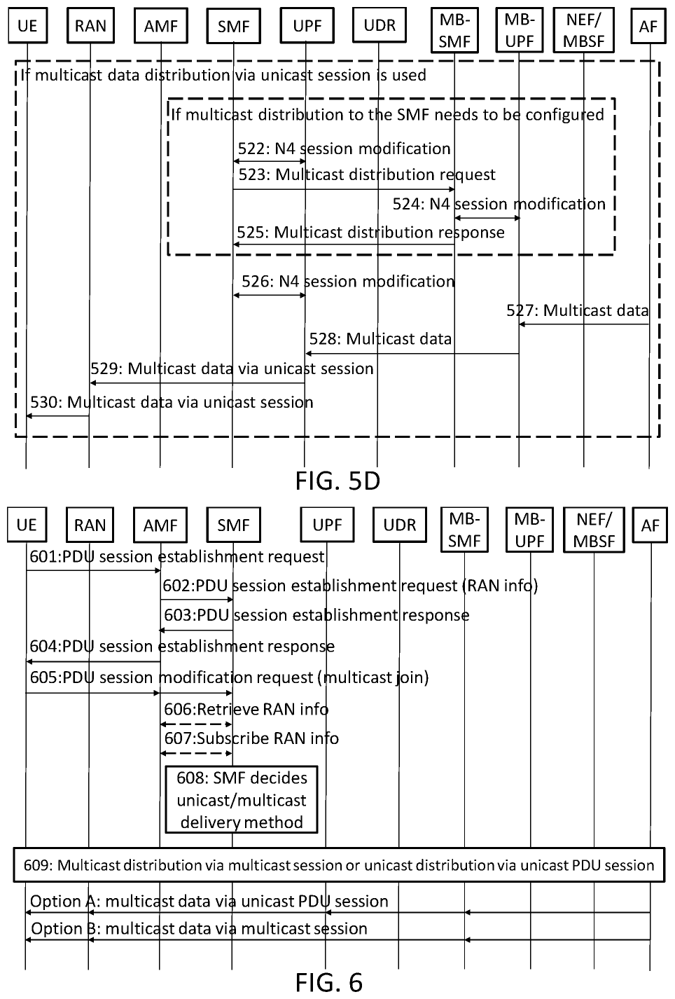

FIGS. 5A to 5D shows flowcharts of a procedure of multicast service provision according to an embodiment of the present disclosure. In step 501 shown in FIG. 5A, the service provider may invoke the services provided by the NEF/MBSF to provide the multicast information (e.g. multicast group configuration). The multicast information is used to identify (e.g., IP Address of multicast data) and reserve resources for the multicast service. The NEF/MBSF selects MB-SMF controlling an MB-UPF serving as ingress point for the multicast data and creates a multicast context and stores related information including the MB-SMF ID in the UDR. The MB-SMF may request the MB-UPF to allocate an IP address and Port for ingress multicast traffic, which is then provided to the service provider via NEF/MBSF.

In step 502, the UE registers in the public land mobile network (PLMN) and requests establishing a PDU session. The UE also indicates its capability to receive multicast data over the radio.

In step 503, the service provider announces the availability of multicast service using a higher layer (e.g., application layer). In an embodiment, the announcement includes at least a multicast address of a multicast group that the UE can join.

In step 504, the UE sends a PDU session modification request (and/or PDU session establishment request) either upon a request from the higher layer or upon a detection by a lower layer of UE joining a multicast group. The PDU session modification request may include information about multicast group, which the UE wants to join.

In step 505, the AMF invokes Nsmf_PDUSession_UpdateSMContext (comprising, e.g., session management (SM) context ID, N1 SM container (e.g. PDU Session modification request with the multicast information)).

If the SMF has no cached knowledge about multicast context, steps 506 and 507 may be performed.

In step 506, if the SMF has no information about the multicast context for the indicated multicast group, the SMF checks at the UDR whether the multicast context for the multicast group (e.g. address) exists in the system. If the multicast context for the multicast group does not exist, the SMF creates the multicast context when the first UE joins the multicast group, stores the multicast context including itself as a multicast controlling SMF in the UDR, and configures the UPF to handle the multicast data distribution (SMF and MB-SMF are collocated and UPF and MB-UPF are collocated in this flow). In the condition that the first UE joining the multicast group, the MB-UPF may also have to join the multicast tree towards the service provider; the MB-SMF may request the MB-UPF to join the multicast tree when configuring the MB-UPF. If the multicast context already exists in the UDR, the SW′ retrieves the related information, including information related to the MB-SMF controlling the multicast ingress point.

In step 507, if the SMF has no information about the multicast context for the indicated multicast group, the SMF interacts with the MB-SMF to retrieve the related quality-of-service (QoS) information.

If the UE supports the reception of multicast data and RAN supports MBS, steps 508 to 521 shown in FIGS. 5B and 5C are performed.

In step 508 shown in FIG. 5B, the SMF requests the AMF to transfer a message to the RAN node by using the Namf_N1N2MessageTransfer service (e.g. N2 SM information (PDU session ID, multicast context ID, MB-SMF ID, multicast QoS flow information), N1 SM container (PDU Session Modification Command (PDU session ID, multicast information (multicast context ID, multicast QoS flow information, multicast address)) to:
create a multicast context in the RAN, if the multicast context does not exist; and
inform about the relation between the multicast context and the UE's PDU session.

In step 509, the N2 session modification request is sent to the RAN. This request is sent in the UE context by using the PDU session resource modify request message enhanced with multicast related information, which includes a multicast group identity (e.g. multicast address), multicast session context ID, and multicast flow information such as multicast QoS flow ID and associated QoS information. The RAN uses the multicast group identity to determine that the session modification procedure corresponds to one multicast group. In other words, the RAN acknowledges which UEs are receiving the same multicast data from the multicast group identity. When the RAN receives a session modification request for a previously unknown multicast group identity, the RAN configures resources to serve this multicast group.

In step 510, the N1 SM container (PDU Session Modification Command) is provided to the UE.

In step 511, the RAN performs necessary access network resource modifications (e.g. configuration of PTP and/or PTM bearers). The RAN node checks whether the user plane for the multicast group/context distribution has been established towards the RAN node. If the RAN supports the MBS, the RAN configures the UE for receiving the multicast data via multicast session.

If the RAN supports the MBS and no user plane for multicast session distribution towards the RAN node has been established, steps 512 to 515 are executed.

In step 512, the RAN node selects the AMF to reach the MB-SMF and transmits a multicast session distribution request (comprising, e.g., MB-SMF ID, multicast context/group ID) towards the AMF.

In step 513, the AMF forwards the multicast session distribution request towards the MB-SMF.

In step 514, the MB-SMF sends a multicast session distribution response to the AMF, where the multicast session distribution response indicates in the downlink tunnel information the transport multicast address for the multicast session.

In step 515, the AMF forwards the multicast session distribution response to the RAN node.

In step 516 shown in FIG. 5C, the RAN sends the session modification response to the AMF.

In step 517, the AMF transfers the session modification response received from the RAN to the SMF. The SMF determines that the shared tunnel is used for multicast packets transferring and the interaction with the UPF is not needed.

In step 518, the MB-UPF receives multicast PDUs (i.e. multicast data) from AF.

In step 519, the MB-UPF sends multicast PDUs to the multicast session distribution to the RAN. There is only one tunnel per multicast distribution session and RAN node.

In step 520, the RAN selects PTM or PTP radio bearer to deliver the multicast PDUs to UEs that have joined in the multicast group.

In step 521, the RAN performs the transmission using the selected bearer.

If the UE does not support the reception of multicast data and/or if the RAN node does not support MBS, steps 522 to 530 are performed, wherein steps 522 to 525 are performed when the user plane for multicast group distribution towards the SMF has not yet been established.

In step 522, if unicast transport for the multicast data between the UPF and the MB-UPF is used, the SMF requests the UPF to allocate a downlink tunnel endpoint (e.g. an IP address and a GTP-U TED).

In step 523, the SMF signals (e.g. transmits) a request for the multicast group distribution (e.g. including multicast context/group ID, downlink tunnel info) towards the MB-SMF.

In step 524, the MB-SMF configures the MB-UPF to transmit the multicast data towards UPF, e.g., based on the received IP address and GTP-U TED.

In step 525, the MB-SMF sends a multicast group distribution response to the SMF.

In step 526, the SMF configures the UPF to receive the multicast data and forwards the data within unicast transport.

In step 527, the MB-UPF receives multicast PDUs (i.e. multicast data) from the AF.

In step 528, the MB-UPF sends multicast PDUs to the UPF. There is only one tunnel per multicast group distribution and destination UPF.

In step 529, the UPF forwards the multicast data via unicast PDU session to the RAN node.

In step 530, the RAN node forwards the multicast data via unicast PDU session.

In an embodiment, the multicast data delivery method of transmitting multicast data to a specific UE may be unicast, i.e. using PDU session, or be multicast, i.e. using multicast session. When a UE receives multicast data, the UE may move across NG-RANs and it is possible that the UE moves from a source RAN node that does not support MBS to a target RAN node that supports MBS. In this case, it might be unclear how to support the delivery method switch from unicast to multicast in the target RAN. This disclosure provides a mechanism to support the delivery method switch from unicast to multicast, e.g., caused by the inter-RAN handover.

In an embodiment, a UE camping in a source RAN which does not support the MBS receives multicast data via the unicast PDU session. When the UE moves to a target RAN which supports the MBS, the unicast PDU session may be converted to the multicast session. The following embodiments illustrate a multicast service join procedure and the procedure for delivery method switch from unicast to multicast due to inter-RAN handover based on at least two different architecture alternatives.

### Embodiment 1: Multicast Service Join Procedure

FIG. 6 shows a multicast service join procedure according to an embodiment of the present disclosure.

In step 601, the UE sends a PDU session establishment request to the AMF.

In step 602, the AMF sends the PDU session establishment request to the SMF. In an embodiment, the AMF may provide the RAN MBS capability (e.g. the capability of RAN supporting the MBS and/or whether the RAN supports the MBS) or an identifier of the RAN to the SMF. In an embodiment, the AMF may notify the SMF the MBS capability of the target RAN or the identifier of the RAN when the RAN supports the MBS.

In step 603, the SMF sends a PDU session establishment response to the AMF. In an embodiment, via the PDU session establishment response, the SMF may (implicitly) subscribe to the AMF for notifications of the RAN MBS capability or RAN identifier because of UE mobility. When a UE receiving multicast data via either unicast PDU session or multicast session moves across RANs (e.g. from a source RAN to a target RAN), the AMF may notify the SMF the MBS capability or the identifier of a target RAN. In an embodiment, the AMF may notify the SMF the MBS capability of the target RAN or the identifier of the target RAN when the target RAN supports MBS. In an embodiment, the AMF services may provide a new parameter (e.g. RAN MBS capability) to be subscribed by consumer NFs.

In step 604, the AMF sends the PDU session establishment response to the UE.

In step 605, the UE sends a PDU session modification request to join in multicast service.

In step 606, if the AMF does not provide the RAN MBS capability or RAN identifier to the SMF during the PDU session establishment procedure, the SMF retrieves the RAN MBS capability or RAN identifier from the AMF after receiving the multicast join request.

In step 607, if the SMF does not (implicitly) subscribe to the AMF for the RAN MBS capability or RAN identifier during the PDU session establishment procedure, the SMF may (explicitly) subscribes to the AMF for the RAN MBS capability or RAN identifier due to UE mobility after receiving the multicast join request. In an embodiment, the AMF may provide new service(s) or new service operation(s) to be subscribed by consumer NFs to MBS related RAN information (e.g. RAN MBS capability).

In step 608, based on whether the RAN supports the MBS, the SMF decides (e.g. determines) to use the unicast delivery method or the multicast delivery method for transmitting the multicast data to the UE. If the RAN supports the MBS, the SMF uses multicast delivery method for the UE. As an alternative, if the RAN does not support the MBS, the SMF uses unicast delivery method for the UE.

In step 609, the multicast distribution via multicast session or unicast distribution via unicast PDU session to the UE is established.

As a result, the multicast data may be transmitted via the unicast PDU session (Option A: unicast delivery method) or via the multicast session (Option B: multicast delivery method).

### Embodiment 2: Delivery Method Switch from Unicast to Multicast Due to Inter-RAN Handover Based on 5GS Architecture Enhanced for MBS

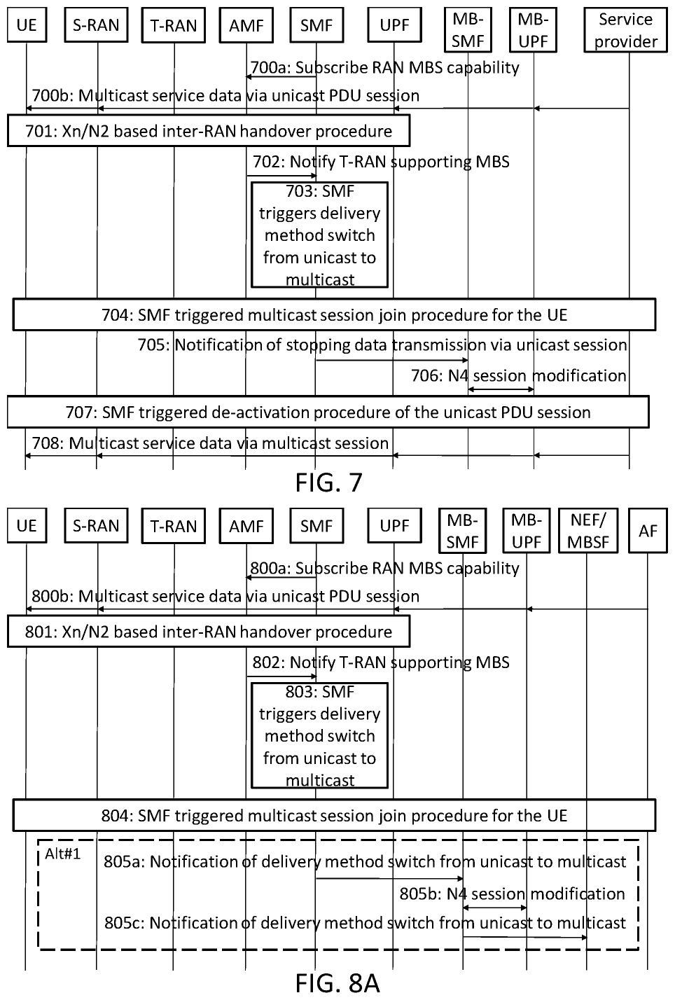

FIG. 7 shows a procedure for delivery method switch from unicast to multicast due to inter-RAN handover based on 5GS architecture enhanced for MBS (e.g. the architecture shown in FIG. 2) according to an embodiment of the present disclosure.

In step 700a, the SMF subscribes to the AMF for notifications of RAN MBS capability. When a UE receiving multicast service data either via unicast PDU session or multicast session moves across RANs (i.e. from source RAN to target RAN), the AMF may notify the SMF the MBS capability of the target RAN or the identifier of the target RAN. In an embodiment, the AMF may notify the SMF the MBS capability of the target RAN or the identifier of the target RAN when the target RAN supports MBS. The AMF services may provide a new parameter, e.g. RAN MBS capability, to be subscribed by consumer NFs. The AMF may provide new service(s) or new service operation(s) to be subscribed by consumer NFs about MBS related information.

In step 700b, the UE has ongoing communications with the service provider and receives multicast service data via unicast PDU session from the source RAN, which does not support the MBS. Due to UE mobility or other reasons, the inter-RAN handover is needed.

In step 701, the Xn based inter-RAN handover procedure or the N2 based inter-RAN handover procedure is executed. The unicast PDU session is handed over to the target RAN as normal PDU session handling. During the handover procedure, the AMF may notify the SMF about the MBS capability of the target RAN or the identifier of the target RAN, which supports MBS.

In step 702, if the AMF did not notify the SMF about the MBS capability or the identifier of the target RAN during the handover procedure, the AMF notifies the SMF about whether target RAN supports the MBS after the completion of the handover procedure.

In step 703, since the UE is receiving the multicast service data via unicast PDU session and the target RAN supports the MBS, the SMF triggers a delivery method switch from unicast to multicast for the UE. If the UE has joined in multiple multicast services, the SMF triggers the delivery method switch from unicast to multicast for all multicast services in which the UE has joined. It should be noted that the SMF may trigger the delivery method switch between unicast and multicast after receiving the MBS capability or the identifier of the target RAN.

In step 704, the SMF triggered multicast session join procedure for the UE is executed and the multicast session is established at the target RAN. If the UE has joined in multiple multicast services, the SMF triggered multicast session join procedure for the UE is executed for each of the multicast services in which the UE has joined.

In step 705, after the completion of the multicast session join procedure, the SMF notifies (e.g. configures, instructs, indicates) the MB-SMF to stop transmitting the multicast service data via the unicast PDU session. In an embodiment, the SMF and MB-SMF may be collocated. If the SMF and the MB-SMF are collocated, this step is executed within SMF/MB-SMF.

In step 706, the MB-SMF configures the MB-UPF to stop transmitting the multicast service data via the unicast PDU session. If the SMF and the MB-SMF are collocated, the UPF and the MB-UPF are also collocated.

In step 707, the SMF triggers a de-activation procedure of the unicast PDU session.

In step 708, the UE receives the multicast service data via the multicast session.

### Embodiment 3: Delivery Method Switch from Unicast to Multicast Due to Inter-RAN Handover Based on 5GS Architecture Enhanced for MBS with Dedicated NFs

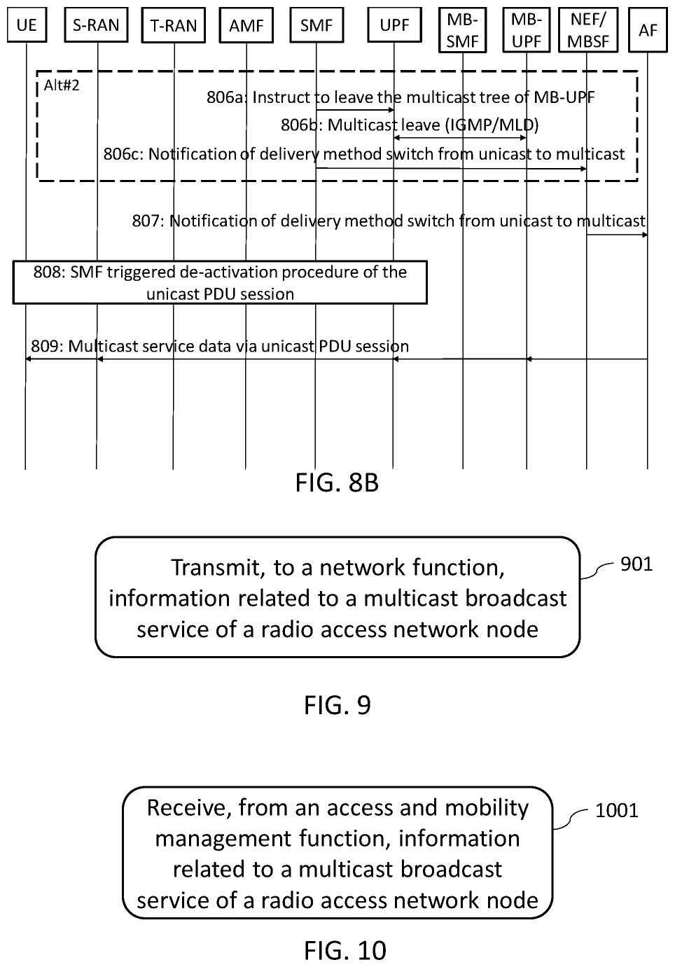

FIGS. 8A and 8B show the procedure for delivery method switch from unicast to multicast due to inter-RAN handover based on 5GS architecture enhanced for MBS with dedicated NFs (e.g. the architecture shown in FIG. 2) according to an embodiment of the present disclosure.

In step 800a shown in FIG. 8A, the SMF subscribes for notifications of RAN MBS capability from the AMF. When a UE who is receiving multicast service data either via unicast PDU session or multicast session moves across RANs, the AMF may notify the SMF about the MBS capability or the identifier of the target RAN. The AMF may notify the SMF the MBS capability of the target RAN or the identifier of the target RAN when the target RAN supports MBS. The AMF services may provide new parameter, e.g. RAN MBS capability, to be subscribed by consumer NFs. The AMF may provide new service(s) or new service operation(s) to be subscribed by consumer NFs about MBS related information.

In step 800b, the UE has ongoing communications with the service provider and receives multicast service data via unicast PDU session from a source RAN, which does not support MBS. Due to UE mobility or other reasons, the inter-RAN handover is needed.

In step 801, the Xn based inter-RAN handover procedure or the N2 based inter-RAN handover procedure is executed. The unicast PDU session is handed over to a target RAN as normal PDU session. During the handover procedure, the AMF may notify the SMF the MBS capability or the identifier of the target RAN, which supports the MBS.

In step 802, if the AMF did not notify the SMF the MBS capability or the identifier of the target RAN during the handover procedure, the AMF notifies the SMF the MBS capability of the target RAN (e.g. the target RAN supporting MBS) after the completion of the handover procedure.

In step 803, since the UE is receiving the multicast service data via unicast PDU session and the target RAN supports the MBS, the SMF triggers a delivery method switch from unicast to multicast for the UE. If the UE has joined in multiple multicast services, the SMF triggers the delivery method switch from unicast to multicast for all multicast services in which the UE has joined. It should be noted that the SMF may trigger the delivery method switch between unicast and multicast after receiving the MBS capability or the identifier of the target RAN.

In step 804, the SMF triggered multicast session join procedure for the UE is executed and the multicast session is established at the target RAN. If the UE has joined in multiple multicast services, the SMF triggered multicast session join procedure for the UE is executed for each of the multicast services in which the UE has joined.

After the completion of the multicast session join procedure, steps 805a to 805c shown in FIG. 8A (i.e. alternative 1 (alt #1)) or steps 806a to 806c shown in FIG. 8B (i.e. alternative 2 (alt #2)) are performed.

In step 805a, the SMF notifies the MB-SMF that the delivery method for the UE has been switched from unicast to multicast and instruct the MB-SMF to stop transmitting the multicast service data via the unicast PDU session. The SMF and MB-SMF may be collocated. If the SMF and the MB-SMF are collocated, this step is executed within the SMF/MB-SMF.

In step 805b, the MB-SMF configures the MB-UPF to stop transmitting the multicast service data via the unicast PDU session. In an embodiment, the SMF and the MB-SMF are collocated and the UPF and the MB-UPF are also collocated.

In step 805c, the MB-SMF may notify the NEF/MBSF that the delivery method for the UE has been switched from unicast to multicast.

As an alternative, in step 806a, the SMF instructs the UPF to leave the multicast tree of the MB-UPF.

In step 806b, the UPF sends a Multicast Leave (e.g. IGMP (Internet Group Management Protocol) and/or MLD (Multicast Listener Discovery)) message to the MB-UPF.

In step 806c, the SMF may notify the NEF/MBSF that the delivery method for the UE has been switched from unicast to multicast.

In step 807, the NEF/MBSF may notify the AF that the delivery method for the UE has been switched from unicast to multicast.

In step 808, the SMF may trigger the de-activation procedure of the unicast PDU session.

In step 809, the UE receives the multicast service data via multicast session.

According to an embodiment of supporting the delivery method switch from the unicast delivery method to the multicast delivery method caused by an inter-RAN handover procedure, the AMF may perform at least one of:
providing new service(s) or new service operation(s) to be subscribed by consumer NF(s) about the MBS related information,
providing new parameters, e.g. RAN MBS capability, in AMF service(s) to be subscribed by consumer NF(s), or
sending notification to SMF to indicate the RAN supports/does not support MBS.

In an embodiment, the AMF may further send notification to SMF to indicate the target RAN supports/does not support MBS during the Xn based inter-RAN handover procedure or the N2 based inter-RAN handover procedure.

In an embodiment, the AMF further sends notification to SMF to indicate the target RAN supports/does not support MBS after the completion of the Xn based inter-RAN handover procedure or the N2 based inter-RAN handover procedure.

According to an embodiment of supporting the delivery method switch from the unicast delivery method to the multicast delivery method caused by an inter-RAN handover procedure, the SMF may perform at least one of:
subscribing for notifications of RAN MBS capability from the AMF
receiving notification from AMF indicating the RAN supports/does not support MBS,
triggering delivery method switch from unicast to multicast,
triggering multicast session join procedure,
sending notification to MB-SMF to stop data transmission via the unicast PDU session,
instructing the UPF to leave the multicast tree of MB-UPF,
sending notification to NEF/MBSF to indicate that the delivery method for the UE has been switched from unicast to multicast,
triggering the de-activation procedure of the unicast PDU session.

In an embodiment, the SMF further receives, from the AMF, a notification indicating that the target RAN supports or does not support the MBS during the Xn based inter-RAN handover procedure or the N2 based inter-RAN handover procedure.

In an embodiment, the SMF further receives, from the AMF, a notification indicating that the target RAN supports or does not support the MBS after the completion of the Xn based inter-RAN handover procedure or the N2 based inter-RAN handover procedure.

In an embodiment, when the UE receives multicast service data via the unicast PDU session and the target RAN supports MBS, the SMF triggers a delivery method switch from unicast to multicast for the UE.

According to an embodiment of supporting the delivery method switch from the unicast delivery method to the multicast delivery method caused by an inter-RAN handover procedure, the MB-SMF performs at least one of:
receiving notification from the SMF to stop data transmission via the unicast PDU session,
configuring the MB-UPF to stop transmitting the multicast service data via the unicast PDU session, or
sending notification to the NEF/MBSF that the delivery method for the UE has been switched from unicast to multicast.

According to an embodiment of the NEF/MBSF supporting the delivery method switch from the unicast delivery method to the multicast delivery method caused by an inter-RAN handover procedure, the NEF/MBSF performs at least one of:
receiving, from the SMF or MB-SMF, notification indicating that the delivery method for the UE has been switched from unicast to multicast, or
sending, to the AF, a notification indicating that the delivery method for the UE has been switched from unicast to multicast.

FIG. 9 shows a flowchart of a process according to an embodiment of the present disclosure. The process shown in FIG. 9 may be used in an AMF (e.g. a communication node comprising (e.g. performing functions of) the AMF) and comprises the following step:

Step 901: Transmitting, to a network function, information related to a multicast broadcast service of a radio access network node.

More specifically, the AMF provides a functionality of transmitting information related to an MBS of a RAN node, e.g., to a network function (e.g. SMF). For example, the information may indicate a capability of the RAN node supporting the MBS or whether the RAN node supports the MBS.

In an embodiment, the AMF may receive a subscription of the information related to the MBS of the RAN node from the network function, e.g., before transmitting the information to the network function.

In an embodiment, the information related to the multicast broadcast service of the RAN node is transmitted during or after at least one of a PDU session establishment procedure, a multicast join procedure or a handover procedure (e.g. inter RAN handover procedure).

In an embodiment, the information comprises an identifier of the RAN node.

FIG. 10 shows a flowchart of a process according to an embodiment of the present disclosure. The process shown in FIG. 10 may be used in an SMF (e.g. a communication node comprising (e.g. performing functions of) the SMF and/or MB-SMF) and comprises the following step:

Step 1001: Receive, from an access and mobility management function, information related to a multicast broadcast service of a radio access network node.

In FIG. 10, the SMF may receive information related to an MBS of a RAN node, e.g. from an AMF. For example, the information may indicate a capability of the RAN node supporting the MBS or whether the RAN node supports the MBS.

In an embodiment, the SMF may subscribe the information related to the MBS of the RAN node, e.g., before receiving the information related to the MBS of the RAN node.

In an embodiment, the SMF subscribes the information during or after at least one of a PDU session establishment procedure or a multicast join procedure.

In an embodiment, the information related to the MBS of the RAN node is received during or after at least one of a PDU session establishment procedure, a multicast join procedure or a handover procedure (e.g. inter RAN handover procedure).

In an embodiment, the information related to the MBS of the RAN node indicates the capability of the RAN node supporting the MBS (e.g. whether the RAN node supports the MBS).

In an embodiment, the information related to the MBS of the RAN node comprises an identifier of the RAN node.

In an embodiment, the SMF triggers a delivery method switch between unicast and multicast when the SMF receives the information indicating the capability of the RAN node supporting the multicast broadcast service or the identifier of the radio access network node.

In an embodiment, the SMF triggers a delivery method switch between a unicast method and a multicast method for a multicast service of a wireless terminal (e.g. UE).

In an embodiment, the information related to the MBS of the RAN node indicates that the RAN node supports the MBS.

In an embodiment, the SMF triggers a delivery method switch from unicast to multicast when the information indicating that the RAN node supports the multicast broadcast service or the identifier of the radio access network node.

In an embodiment, the SMF triggers a delivery method switch from a unicast method to a multicast method and a multicast session joining procedure for the multicast service (e.g. at least one multicast service) for a wireless terminal.

In an embodiment, the SMF stops a UPF from transmitting data of the multicast service to a wireless terminal via a unicast session.

In an embodiment, the SMF stops the UPF from transmitting data of the multicast service to the wireless terminal via the unicast session by transmitting, to MB-SMF or the UPF, a notification (e.g. instruction) of stopping transmitting data of the multicast service to the wireless terminal via the unicast session.

In an embodiment, the UPF comprises a MB-UPF.

In an embodiment, the SMF transmits a notification indicating a delivery method switch from a unicast method to a multicast method for a multicast service of a wireless terminal to NEF or MBSF.

In an embodiment, the SMF may trigger a deactivation procedure of a unicast session.

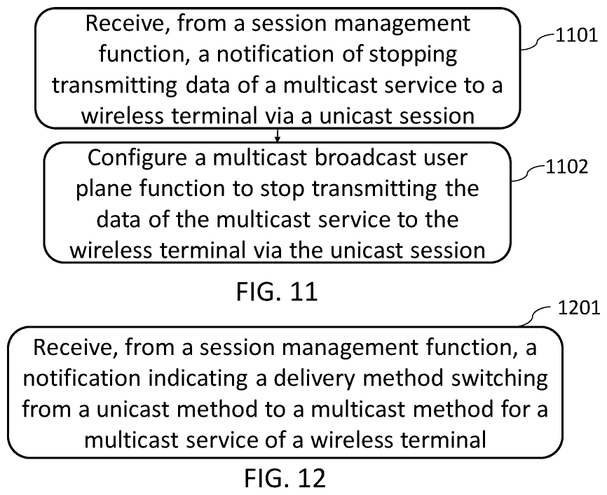

FIG. 11 shows a flowchart of a process according to an embodiment of the present disclosure. The process shown in FIG. 11 may be used in an MB-SMF (e.g. a communication node comprising (e.g. performing functions of) the MB-SMF) and comprises the following steps:

Step 1101: Receiving, from a session management function, a notification of stopping transmitting data of a multicast service to a wireless terminal via a unicast session.

Step 1102: Configuring a multicast broadcast user plane function to stop transmitting the data of the multicast service to the wireless terminal via the unicast session.

In the process shown in FIG. 11, the MB-SMF receives a notification of stopping transmitting data of a multicast service to a wireless terminal (e.g. UE) via a unicast session (e.g. unicast PDU session). Based on the notification, the MB-SMF configures a corresponding MB-UPF to stop transmitting the data of the multicast service to the wireless terminal via the unicast session.

In an embodiment, the MB-SMF further transmits a notification indicating a delivery method switch from a unicast method to a multicast method for the multicast service of the wireless terminal, to an NEF or MBSF,

FIG. 12 shows a flowchart of a process according to an embodiment of the present disclosure. The process shown in FIG. 12 may be used in an NEF or MBSF (e.g. a communication node comprising (e.g. performing functions of) the MB-SMF) and comprises the following step:

Step 1201: Receive, from a session management function, a notification indicating a delivery method switch from a unicast method to a multicast method for a multicast service of a wireless terminal.

In the process shown in FIG. 12, the NEF/MBSF receives a notification indicating a delivery method switch from a unicast method to a multicast method for a multicast service of a wireless terminal (e.g. UE) from an SMF. Note that, the SMF may be an MB-SMF or comprises (functions of) the MB-SMF.

In an embodiment, the delivery method switch may be triggered by (e.g. in response to) an inter RAN handover procedure, e.g., which hands the wireless terminal from a serving RAN node to a target RAN node.

In an embodiment, the NEF/MBSF may transmit (e.g. forward) the notification to an AF.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand example features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described example embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

1. A wireless communication method for use in an access and mobility management function, the method, comprising:
transmitting, to a network function, information related to a multicast broadcast service of a radio access network node.

2. The wireless communication method of claim 1, further comprising:
receiving, from the network function, a subscription of the information related to the multicast broadcast service of the radio access network node.

3. The wireless communication method of claim 1, wherein the information related to the multicast broadcast service of the radio access network node is transmitted during or after at least one of a packet data unit (PDU) session establishment procedure, a multicast join procedure or a handover procedure,
wherein the information related to the multicast broadcast service of the radio access network node indicates a capability of the radio access network node supporting the multicast broadcast service,
wherein the information comprises an identifier of the radio access network node.

4. The wireless communication method of claim 1, wherein the network function is a session management function.

5. A wireless communication method for a session management function, the method comprising:
receiving, from an access and mobility management function, information related to a multicast broadcast service of a radio access network node.

6. The wireless communication method of claim 5, further comprising:
subscribing, to the access and mobility management function, the information related to the multicast broadcast service of the radio access network node.

7. The wireless communication method of claim 6, wherein the information is subscribed during or after at least one of a packet data unit (PDU) session establishment procedure or a multicast join procedure.

8. The wireless communication method of claim 5, wherein the information related to the multicast broadcast service of the radio access network node is received during or after at least one of a packet data unit (PDU) session establishment procedure, a multicast join procedure or a handover procedure,
wherein the information related to the multicast broadcast service of the radio access network node indicates a capability of the radio access network node supporting the multicast broadcast service,
wherein the information related to the multicast broadcast service of the radio access network node comprises an identifier of the radio access network node.

9. The wireless communication method of claim 8, further comprising:
triggering a delivery method switch between a unicast method and a multicast method for a multicast service of a wireless terminal.

10. The wireless communication method of claim 5, wherein the information related to the multicast broadcast service of a radio access network node indicates the radio access network node supports the multicast broadcast service.

11. The wireless communication method of claim 10, further comprising:
triggering a delivery method switch from a unicast method to a multicast method for at least one multicast service of a wireless terminal and a multicast session joining procedure of the at least one multicast service for the wireless terminal.

12. The wireless communication method of claim 9, further comprising:
stopping a user plane function from transmitting data of a multicast service to a wireless terminal via a unicast session.

13. The wireless communication method of claim 12, wherein the stopping the user plane function from transmitting data of the multicast service to the wireless terminal via the unicast session comprises:
transmitting, to a multicast broadcast session management function or the user plane function, a notification of stopping transmitting data of the multicast service to the wireless terminal via the unicast session.

14. The wireless communication method of claim 12, wherein the user plane function comprises a multicast broadcast user plane function.

15. The wireless communication method of claim 9, further comprising:
transmitting, to a network exposure function or a multicast broadcast service function, a notification indicating a delivery method switch from a unicast method to a multicast method for a multicast service of a wireless terminal.

16. The wireless communication method of claim 9, further comprising:
triggering a deactivation procedure of a unicast session.

17. A communication node comprising an access and mobility management function, comprising:
a communication unit, configured to transmit, to a network function, information related to a multicast broadcast service of a radio access network node.

18. The wireless communication node of claim 17, the communication unit further configured to:
receive, from the network function, a subscription of the information related to the multicast broadcast service of the radio access network node.

19. The wireless communication node of claim 17, wherein the information related to the multicast broadcast service of the radio access network node is transmitted during or after at least one of a packet data unit (PDU) session establishment procedure, a multicast join procedure or a handover procedure,
wherein the information related to the multicast broadcast service of the radio access network node indicates a capability of the radio access network node supporting the multicast broadcast service,
wherein the information comprises an identifier of the radio access network node.

20. The wireless communication node of claim 17, wherein the network function is a session management function.
